(19) United States
(12) Patent Application Publication
(10) Pub. No.: US 2024/0329233 A1
(43) Pub. Date: Oct. 3, 2024

(54) METHOD AND SYSTEM TO DETECT OBJECTS IN SEALED PACKAGES BASED ON VIRTUAL ANTENNA-BASED DELAY-MULTIPLY-AND-SUM (VA-DMAS)

(71) Applicant: Tata Consultancy Services Limited, Mumbai (IN)

(72) Inventors: SOUMYA CHAKRAVARTY, Kolkata (IN); ARIJIT CHOWDHURY, Kolkata (IN); ARINDAM RAY, Kolkata (IN); TAPAS CHAKRAVARTY, Kolkata (IN); ACHANNA ANIL KUMAR, Bangalore (IN); CHIRABRATA BHAUMIK, Kolkata (IN); ARPAN PAL, Kolkata (IN)

(73) Assignee: Tata Consultancy Services Limited, Mumbai (IN)

(21) Appl. No.: 18/393,219

(22) Filed: Dec. 21, 2023

(30) Foreign Application Priority Data
Mar. 30, 2023 (IN) 202321024037

(51) Int. Cl. G01S 13/88; G01S 7/41; G01S 13/86; G06V 10/56; G06V 10/764; G06V 20/50; G06V 20/60

(52) U.S. Cl. CPC G01S 13/887; G01S 7/41; G01S 13/867; G06V 10/56; G06V 10/764; G06V 20/50; G06V 20/60

(57) ABSTRACT

In recent years, researchers have been focusing on the capabilities of radar-based microwave imaging in detection of concealed objects in sealed packages, through-the-wall imaging approach which faces challenge in suppress unwanted return signals. This disclosure relates a method to detect objects in sealed packages. One or more parameters associated with a conveyor are received to obtain a scan time of a radar. A sequence of scanning is determined between one or more antenna pairs based on corresponding position. A sealed package is scanned in the predetermined sequence to obtain range-time datasets with identifiers. The range-time datasets are processed by virtual antenna-pattern-weighted delay-multiply-and-sum technique based on one or more positions of each virtual antenna to determine one or more object signature images. A trained classification model based on extracted features associated with one or more object signature images.

### PRIORITY CLAIM

This U.S. patent application claims priority under 35 U.S.C. § 119 to: India application Ser. No. 202321024037, filed on Mar. 30, 2023. The entire contents of the aforementioned application are incorporated herein by reference.

### TECHNICAL FIELD

This disclosure relates generally to the field of object detection systems, and, more particularly, to method and system to detect objects in sealed packages based on virtual antenna-based delay-multiply-and-sum (VA-DMAS).

### BACKGROUND

The popular applications of microwave imaging (MI), such as synthetic aperture radar (SAR), ground penetrating radar (GPR) and medical imaging (CT scan) are well-known and widely employed. In recent years, researchers have been focusing on the capabilities of radar-based microwave imaging in detection of concealed weapons, through-the-wall imaging, etc. One important application is the screening of sealed packages in typical supply-chain scenarios, where the objects in sealed packages are moved in large quantities over conveyor belts at all times of the day. Many such sealed packages must be inspected daily for the presence of contraband objects, without opening them. In this situation, a microwave imaging (MI) system is envisaged to be more affordable as compared to X-ray machines. Therefore, imaging using ultra-wideband (UWB) radar, because of their high penetration, is an attractive proposition. However, it is known that the image of an object created using microwave radar is not comparable to X-ray image in terms of resolution and estimation of shape of the target object. Hence, implementation of artificial intelligence (AI) in microwave imaging is a superior option and an emerging application for object detection. To create a complete three-dimensional (3D) image of the moving object under test (OUT), it is required to be interrogated from multiple perspectives using a multi-antenna system. Also, antennas with high directionality are preferable, not only for improved image quality, but also to mitigate the problem of unwanted scattering from objects outside the observation window.

The MI systems usually require broadband highly directional antennas along with other associated RF components to measure the reflection data of the test media. Vivaldi antennas display high directivity, i.e., narrow beamwidth over a wide frequency band and thus, are an excellent choice for various microwave imaging applications. However, the incorporation of the radiation pattern of these directional antennas in the imaging algorithms (e.g., Delay-and-Sum) as a synthetic weight factor for improving the image resolution is heretofore unexplored in literature. From the perspective of radar imaging, the delay-and-sum (DAS) algorithm provides a digital beamformer that is widespread owing to its robustness, ease-of-use, and efficiency, making it very compatible with real-time high-speed imaging applications. This algorithm performs a weighted summation of signals, after time-shifting them with predefined delays, to increase the signal intensity in desired direction while suppressing unwanted return signals. The calculation of the weights causes a difference in performance between different DAS beamformers.

### SUMMARY

Embodiments of the present disclosure present technological improvements as solutions to one or more of the above-mentioned technical problems recognized by the inventors in conventional systems. For example, in one aspect, a processor implemented method of detecting objects in sealed packages based on virtual antenna-based delay-multiply-and-sum (VA-DMAS) is provided. The processor implemented method includes at least one of: receiving, via one or more hardware processors, one or more parameters associated with a conveyor; obtaining, via the one or more hardware processors, a scan time of a radar based on the one or more parameters; determining, via the one or more hardware processors, sequence of scanning between one or more antenna pairs based on corresponding position of the one or more antenna pairs; heuristically determining, via the one or more hardware processors, a color threshold value of a predetermined position in a camera observation window on the conveyor; scanning, via the radar connected with the one or more antenna pairs, the sealed package in the predetermined sequence to obtain one or more range-time datasets associated with one or more identifiers; processing, via the one or more hardware processors, the one or more range-time datasets by a virtual antenna-pattern-weighted delay-multiply-and-sum (APW-DMAS) technique based on one or more positions of each virtual antenna to determine one or more object signature images; extracting, via the one or more hardware processors, at least one feature associated with the one or more object signature images; and obtaining, via the one or more hardware processors, a trained classification model based on at least one feature associated with the one or more object signature images. The scan time is divided into equal parts for each antenna pair (Tx-Rx) from the one or more antenna pairs. Time interval between each scan is determined based on the scan time of the radar. If the color threshold value is exceeded as front end of an object under test packed inside a sealed package crosses the predetermined position on the conveyor, and scanning is triggered. The color threshold value corresponds to one or more RGB values. The one or more range-time datasets correspond to one or more reflected signals from the object under test having continuous motion on the conveyer. The trained classification model identifies the class of each object under test from among one or more object under test moving on the conveyor.

In an embodiment, the one or more parameters corresponds to: (i) speed of the conveyor, (ii) length (L) of the conveyor available for imaging that is determined from a position and a beamwidth of the one or more antenna pairs, and (iii) number of scans (M). In an embodiment, the one or more range-time datasets corresponds to a form of a two-dimensional matrix, where the rows are the scans at each time instant, and the columns are the range bins. In an embodiment, the one or more object signature images is determined by a pattern factor derived based on a radiation pattern from the one or more antenna pairs. In an embodiment, the pattern factor corresponds to a synthetic weight factor that heuristically incorporates directivity and gain of each antenna. In an embodiment, a confidence score for an unknown test object is obtained from the trained classification model to recognize if there is a false alarm raised when the object under test is classified.

In another aspect, there is provided a system for detection of objects in sealed packages based on virtual antenna-based delay-multiply-and-sum (VA-DMAS). The system includes a memory storing instructions; one or more communication interfaces; and one or more hardware processors coupled to the memory via the one or more communication interfaces, wherein the one or more hardware processors are configured by the instructions to: receive, one or more parameters associated with a conveyor; obtain, a scan time of a radar based on the one or more parameters; determine, sequence of scanning between one or more antenna pairs based on corresponding position of the one or more antenna pairs; heuristically determine, a color threshold value of a predetermined position in a camera observation window on the conveyor; scan, via the radar connected with the one or more antenna pairs, the sealed package in the predetermined sequence to obtain one or more range-time datasets associated with one or more identifiers; process, the one or more range-time datasets by a virtual antenna-pattern-weighted delay-multiply-and-sum (APW-DMAS) technique based on one or more positions of each virtual antenna to determine one or more object signature images; extract, at least one feature associated with the one or more object signature images; and obtain, a trained classification model based on at least one feature associated with the one or more object signature images. The scan time is divided into equal parts for each antenna pair (Tx-Rx) from the one or more antenna pairs. Time interval between each scan is determined based on the scan time of the radar. If the color threshold value is exceeded as front end of an object under test packed inside a sealed package crosses the predetermined position on the conveyor, and scanning is triggered. The color threshold value corresponds to one or more RGB values. The one or more range-time datasets correspond to one or more reflected signals from the object under test having continuous motion on the conveyer. The trained classification model identifies the class of each object under test from among one or more object under test moving on the conveyor.

In an embodiment, the one or more parameters corresponds to: (i) speed of the conveyor, (ii) length (L) of the conveyor available for imaging that is determined from a position and a beamwidth of the one or more antenna pairs, and (iii) number of scans (M). In an embodiment, the one or more range-time datasets corresponds to a form of a two-dimensional matrix, where the rows are the scans at each time instant, and the columns are the range bins. In an embodiment, the one or more object signature images is determined by a pattern factor derived based on a radiation pattern from the one or more antenna pairs. In an embodiment, the pattern factor corresponds to a synthetic weight factor that heuristically incorporates directivity and gain of each antenna. In an embodiment, a confidence score for an unknown test object is obtained from the trained classification model to recognize if there is a false alarm raised when the object under test is classified.

In yet another aspect, there are provided one or more non-transitory machine readable information storage mediums comprising one or more instructions which when executed by one or more hardware processors causes at least one of: receiving, one or more parameters associated with a conveyor; obtaining, a scan time of a radar based on the one or more parameters; determining, sequence of scanning between one or more antenna pairs based on corresponding position of the one or more antenna pairs; heuristically determining, a color threshold value of a predetermined position in a camera observation window on the conveyor; scanning, via the radar connected with the one or more antenna pairs, the sealed package in the predetermined sequence to obtain one or more range-time datasets associated with one or more identifiers; processing, the one or more range-time datasets by a virtual antenna-pattern-weighted delay-multiply-and-sum (APW-DMAS) technique based on one or more positions of each virtual antenna to determine one or more object signature images; extracting, at least one feature associated with the one or more object signature images; and obtaining, a trained classification model based on at least one feature associated with the one or more object signature images. The scan time is divided into equal parts for each antenna pair (Tx-Rx) from the one or more antenna pairs. Time interval between each scan is determined based on the scan time of the radar. If the color threshold value is exceeded as front end of an object under test packed inside a sealed package crosses the predetermined position on the conveyor, and scanning is triggered. The color threshold value corresponds to one or more RGB values. The one or more range-time datasets correspond to one or more reflected signals from the object under test having continuous motion on the conveyer. The trained classification model identifies the class of each object under test from among one or more object under test moving on the conveyor.

In an embodiment, the one or more parameters corresponds to: (i) speed of the conveyor, (ii) length (L) of the conveyor available for imaging that is determined from a position and a beamwidth of the one or more antenna pairs, and (iii) number of scans (M). In an embodiment, the one or more range-time datasets corresponds to a form of a two-dimensional matrix, where the rows are the scans at each time instant, and the columns are the range bins. In an embodiment, the one or more object signature images is determined by a pattern factor derived based on a radiation pattern from the one or more antenna pairs. In an embodiment, the pattern factor corresponds to a synthetic weight factor that heuristically incorporates directivity and gain of each antenna. In an embodiment, a confidence score for an unknown test object is obtained from the trained classification model to recognize if there is a false alarm raised when the object under test is classified.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a system to detect objects in one or more sealed packages based on a virtual antenna-based delay-multiply-and-sum (VA-DMAS), according to an embodiment of the present disclosure.

FIG. 2 illustrates a schematic block diagram of the system of FIG. 1, according to some embodiments of the present disclosure.

FIG. 3A and FIG. 3B are block diagrams illustrating one or more frames of reference and positions of a virtual antenna respectively, according to an embodiment of the present disclosure.

FIG. 4 is an exemplary graphical representation depicting an imaging using the virtual antenna with a directional pattern after incorporating a pattern factor, according to an embodiment of the present disclosure.

FIG. 5A is a top view of an exemplary broadband coplanar Vivaldi antenna, according to an embodiment of the present disclosure.

FIG. 5B is a bottom view showing a feedline of the exemplary broadband coplanar Vivaldi antenna, according to an embodiment of the present disclosure.

FIG. 5C is a three-dimensional (3D) view showing a substrate height, three dimensional (X, Y, Z) axes, and reference angles of the exemplary broadband coplanar Vivaldi antenna respectively, according to an embodiment of the present disclosure.

FIG. 6 is an exemplary graphical representation depicting a simulated return loss of the Vivaldi antenna, according to an embodiment of the present disclosure.

FIG. 7A is an exemplary graphical representation depicting a simulated radiation pattern of the Vivaldi antenna at 4 GHz and azimuth (X-Z plane) varying with ϕ respectively, according to an embodiment of the present disclosure.

FIG. 7B is an exemplary graphical representation depicting a simulated radiation pattern of the Vivaldi antenna at 4 GHz and Elevation (X-Y plane) varying with θ respectively, according to an embodiment of the present disclosure.

FIG. 8 is a graphical representation depicting a simulated realized gain against a frequency of the Vivaldi antenna, according to an embodiment of the present disclosure.

FIG. 9A and FIG. 9B are flow diagrams illustrating a method of detecting one or more objects in one or more sealed packages based on the virtual antenna-based delay-multiply-and-sum (VA-DMAS), according to an embodiment of the present disclosure.

FIG. 10A and FIG. 10B are exemplary graphical representations depicting a simulated and measured (a) return losses of two antennas, and (b) realized gain vs Frequency of the Vivaldi antenna respectively, according to an embodiment of the present disclosure.

FIG. 11A to FIG. 11F are exemplary graphical representations depicting one or more images obtained by the VA-DMAS from the viewpoints of Tx-Rx1 and Tx-Rx 2, without and with pattern factor, for a representative dataset of: (a) empty box, (b) box containing laptop battery, and (c) box containing a stack of Li-ion batteries respectively, according to an embodiment of the present disclosure.

FIG. 12A to FIG. 12C are exemplary graphical representations depicting one or more images obtained by the VA-DMAS from the combined view, with the pattern factor, for a representative dataset of: (a) empty box, (b) box containing laptop battery, and (c) box containing a stack of Li-ion batteries respectively, according to an embodiment of the present disclosure.

FIG. 13 is an exemplary graphical representation depicting precision and recall values for different classes using a Random Forest classifier, according to an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

There is a need for an effective approach to detect objects in sealed packages. Embodiments of the present disclosure provide a method and system to detect objects in the sealed packages based on machine learning-driven radar imaging. The embodiment of the present disclosure utilizes an ultra-wideband (UWB) pulsed radar along with an imaging technique to detect the presence of objects in the sealed packages. The imaging technique is alternatively referred to as a virtual antenna-based delay-multiply-and-sum (VA-DMAS) technique or an antenna pattern-weighted delay-multiply-and-sum (APW-DMAS) technique. A multi-antenna system is disclosed to interrogate object under test (OUT) in the sealed packages which moves on a conveyor belt, while the radar remains static. For example, to detect the presence of a collection of loosely packed Lithium-ion (Li-ion) batteries inside different-sized packages and distinguish them from other non-battery objects from one or more object signature images. The embodiment of the present disclosure utilizes a modified Delay-and-Sum (DAS) technique which is alternatively referred as the VA-DMAS, to generate machine interpretable image from the radar return data, where the virtual antenna positions are generated by exploiting the motion of the OUT. The one or more object signature images are determined by a pattern factor (PF) derived based on a radiation pattern from one or more antenna pairs i.e., one or more transmitter-receiver (Tx-Rx) antennas.

The pattern factor (PF) corresponds to a synthetic weight factor that heuristically incorporates directivity and gain of each antenna. The pattern factor is used to calculate weights of the VA-DMAS technique for amplification of intensities obtained from the desired object direction, covered by the main beam of the antennas, and to remove the reflections from outside the zone covered by the main beam of the antenna. In an example implementation, the system is designed with high gain, high directivity coplanar Vivaldi antennas, which help to increase the resolution of the formed one or more object signature images. The one or more object signature images are inputted to a feature extractor based on Two-Directional Two-Dimensional Principal Component Analysis (2D2D-PCA). The received back-scattered signal is converted into two-dimensional (2D) image using the VA-DMAS. The two-dimensional image represents shape, size, and object reflectivity vis-à-vis with an aspect angle. Subsequently, the features of interest are drawn from the one or more object signature images, and an appropriate machine learning-based classifier is implemented to obtain a final classification of the one or more object signature images which enables user to identify presence or absence of Lithium-ion (Li-ion) batteries without opening the sealed packages.

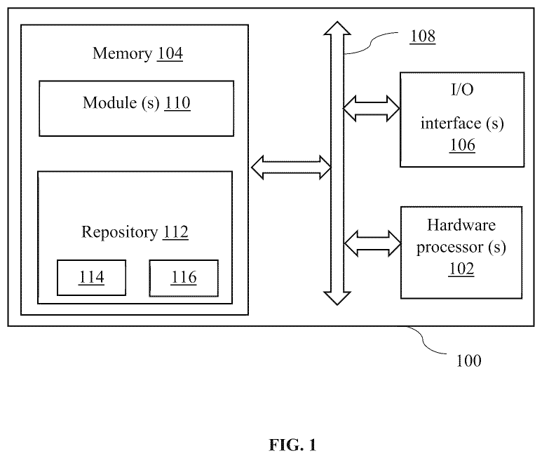

Referring now to the drawings, and more particularly to FIGS. 1 through 13, where similar reference characters denote corresponding features consistently throughout the figures, there are shown preferred embodiments, and these embodiments are described in the context of the following exemplary system and/or method.

FIG. 1 illustrates a system 100 to detect objects in the one or more sealed packages based on an improved virtual antenna-based delay-multiply-and-sum (VA-DMAS), according to an embodiment of the present disclosure. In an embodiment, the system 100 includes one or more processor(s) 102, communication interface device(s) or input/output (I/O) interface(s) 106, and one or more data storage devices or memory 104 operatively coupled to the one or more processors 102. The memory 104 includes a database. The one or more processor(s) processor 102, the memory 104, and the I/O interface(s) 106 may be coupled by a system bus such as a system bus 108 or a similar mechanism. The system 100 is further connected to a radar and antenna unit (not shown in figure) via the I/O interface(s) 106. The one or more processor(s) 102 that are hardware processors can be implemented as one or more microprocessors, microcomputers, microcontrollers, digital signal processors, central processing units, state machines, logic circuitries, and/or any devices that manipulate signals based on operational instructions. Among other capabilities, the one or more processor(s) 102 is configured to fetch and execute computer-readable instructions stored in the memory 104. In an embodiment, the system 100 can be implemented in a variety of computing systems, such as laptop computers, notebooks, hand-held devices, workstations, mainframe computers, servers, a network cloud, and the like.

The I/O interface device(s) 106 can include a variety of software and hardware interfaces, for example, a web interface, a graphical user interface, and the like. The I/O interface device(s) 106 may include a variety of software and hardware interfaces, for example, interfaces for peripheral device(s), such as a keyboard, a mouse, an external memory, a camera device, and a printer. Further, the I/O interface device(s) 106 may enable the system 100 to communicate with other devices, such as web servers and external databases. The I/O interface device(s) 106 can facilitate multiple communications within a wide variety of networks and protocol types, including wired networks, for example, local area network (LAN), cable, etc., and wireless networks, such as Wireless LAN (WLAN), cellular, or satellite. In an embodiment, the I/O interface device(s) 106 can include one or more ports for connecting a number of devices to one another or to another server.

The memory 104 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. In an embodiment, the memory 104 includes a plurality of modules 110 and a repository 112 for storing data processed, received, and generated by the plurality of modules 110. The plurality of modules 110 may include routines, programs, objects, components, data structures, and so on, which perform particular tasks or implement particular abstract data types.

Further, the database stores information pertaining to inputs fed to the system 100 and/or outputs generated by the system (e.g., data/output generated at each stage of the data processing) 100, specific to the methodology described herein. More specifically, the database stores information being processed at each step of the proposed methodology.

Additionally, the plurality of modules 110 may include programs or coded instructions that supplement applications and functions of the system 100. The repository 112, amongst other things, includes a system database 114 and other data 116. The other data 116 may include data generated as a result of the execution of one or more modules in the plurality of modules 110. Further, the database stores information pertaining to inputs fed to the system 100 and/or outputs generated by the system (e.g., at each stage), specific to the methodology described herein. Herein, the memory for example the memory 104 and the computer program code configured to, with the hardware processor for example the processor 102, causes the system 100 to perform various functions described herein under.

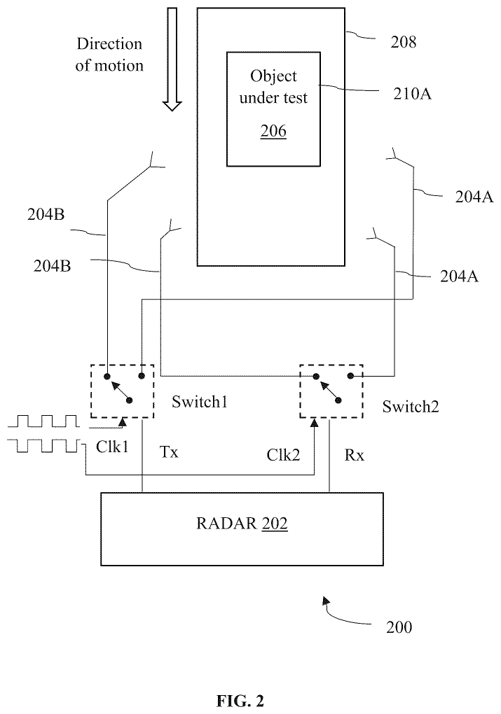

FIG. 2 illustrates a schematic block diagram of the system 100 of FIG. 1, according to some embodiments of the present disclosure. The system 200 may be an example of the system 100 (FIG. 1). In an example embodiment, the system 200 may be embodied in, or is in direct communication with the system, for example the system 100 (FIG. 1). The system 200 is configured to detect objects in the one or more sealed packages based on an improved virtual antenna-based delay-multiply-and-sum (VA-DMAS). The system 200 includes a radar 202, one or more antenna pairs 204A-N, an object (206) under test (OUT), a conveyor 208, and the one or more sealed packages 210A-N. The system 200 is configured to receive one or more parameters associated with the conveyor 208. The one or more parameters correspond to: (i) speed of the conveyor 208, (ii) length (L) of the conveyor 208 available for imaging that is determined from a position and a beamwidth of the one or more antenna pairs 204A-N, and (iii) number of scans (M). The system 200 is configured to obtain a scan time of a radar based on the one or more parameters.

$$\\ Scan Time = \frac{L}{speed}$$

where a span of the observation window, i.e., the length of the conveyor belt available for imaging, is calculated from the position and beamwidths of the one or more antenna pairs 204A-N. The length is denoted as L. The scan time is divided into equal parts for each antenna pair (Tx-Rx) from one or more antenna pairs 204A-N. The time interval between each scan is determined based on the scan time of the radar 202.

$$\\ Scan Interval = \frac{No . of scans}{Scan Time}$$

In an embodiment, the switching time between the antenna pairs is ignored. In an embodiment, time available for scanning by the radar 202 is determined by the speed of the conveyor 208. A sequence of scanning between the one or more antenna pairs 204A-N is determined based on corresponding position of the one or more antenna pairs 204A-N. A color threshold value of a predetermined position in a camera observation window is heuristically determined on the conveyor 208. If the color threshold value is exceeded as front end of the object 206 under test (OUT) packed inside the sealed package 210A crosses the predetermined position on the conveyor 208, and scanning is triggered. In an embodiment, the color threshold value corresponds to one or more RGB values. The sealed package 210A in the predetermined sequence is scanned by the radar 206 connected with the one or more antenna pairs 204A-N, to obtain one or more range-time datasets associated with one or more identifiers. The one or more range-time datasets correspond to one or more reflected signals from the object 206 under test having continuous motion on the conveyer. In an embodiment, the one or more range-time datasets may further correspond to a form of a two-dimensional matrix, where the rows are the scans at each time instant, and the columns are the range bins. The one or more range-time datasets are processed by the virtual antenna-pattern-weighted delay-multiply-and-sum (APW-DMAS) technique based on one or more positions of each virtual antenna to determine one or more object signature images. The one or more object signature images is determined by the pattern factor derived based on a radiation pattern from the one or more antenna pairs 204A-N. The pattern factor corresponds to a synthetic weight factor that heuristically incorporates directivity and gain of each antenna.

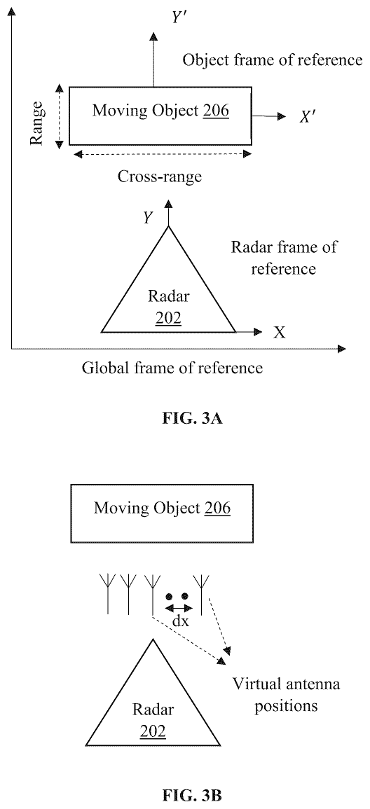

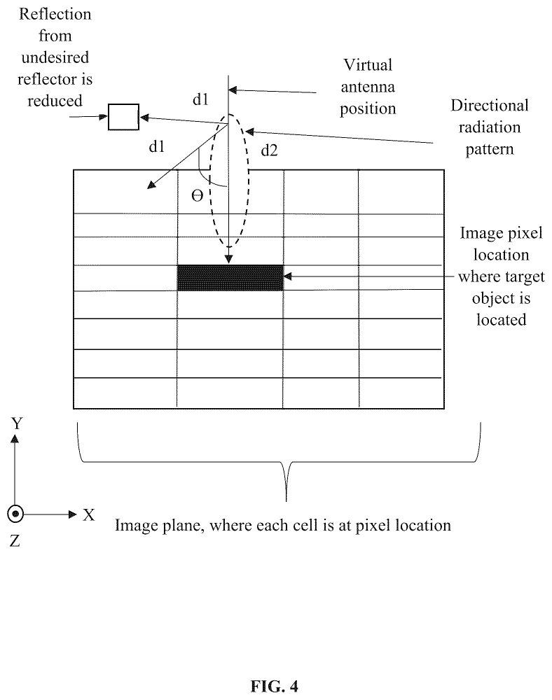

FIG. 3A and FIG. 3B are block diagrams illustrating one or more frames of reference and the one or more positions of the virtual antenna respectively, according to an embodiment of the present disclosure. FIG. 4 is an exemplary graphical representation depicting an imaging using the virtual antenna with a directional pattern after incorporating the pattern factor, according to an embodiment of the present disclosure. In an embodiment, the antenna is designed for a narrow beamwidth (i.e., a high directivity) and a high gain (relatively flat gain over an operating frequency) to provide an improved resolution of one or more object signature images on the incoming package due to the increased angular resolution obtained from the greater directivity. The effect of the directed beam is incorporated in the imaging technique by introducing the concept of a synthetic multiplier to the image pixel values. This multiplier is referred to as the pattern factor, which refines the obtained one or more object signature images by suppressing noise and removing unwanted artifacts. Considering, a distance and an angle of a pixel location from the antenna location, instead of just the distance. To eliminate an ambiguity due to strong reflection from an undesired reflector, a normalized radiation patterns of the designed antenna is incorporated, from the azimuth and elevation planes, into the imaging technique to form a synthetically focused one or more object signature images. If there is a strong reflection coming from an off-axis angle, a weight is reduced in proportion to a boresight so that the contribution of the reflection from the boresight is accentuated. Then, the pixel at distance d1 is now white, indicating little to no reflection intensities at that point. The reduction in weight follows the normalized values of the antenna radiation at each angle from boresight which is referred to as the pattern factor (PF).

In an exemplary embodiment, that the UWB Radar is scanning the OUT 206 in motion through two pairs of transmit-receive (Tx-Rx) antennas, observing the scene from two different perspectives, where the radar 202 scanning is done sequentially between the two pairs of the transmit-receive (Tx-Rx) antennas. Considering a configuration of the radar 202 and the one or more parameters, the virtual antenna-based delay-multiply-and-sum (VA-DMAS) technique is implemented on the data for obtaining a horizontal cross-section image of the object in a camera observation window. In an exemplary embodiment, considering two reference frames, Frame 1: the radar 202 frame of reference (i.e., the radar 202 as an origin), Frame 2: object frame of reference (i.e., center of the moving package as an origin). The object is moving in a straight line on the conveyor 208, and the radar 202 is stationary. The origin translation from the frame 1 to the frame 2 effectively indicates that the radar is moving in a virtual straight line in exact opposite direction as the actual movement of the one or more sealed package 210A-N, thereby the positions of the virtual antenna are created. In an embodiment, for small linear distances dx moved by the OUT 206, then the back-scattered signals from a same scatterer for different echoes are centered at the same range bin, where the dx is determined from the speed of belt of the conveyor 208, and the total number of scans.

The back-scattered signal from the OUT 206, obtained through each antenna pair in the form of a range-time matrix is pre-processed. For example, M₁, an envelope of the motion-filtered data obtained, is a m×n matrix (i.e., m rows=total number of scans and n columns=total number of range bins). Then the two matrices from each antenna pair are combined vertically in the direction of rows. The observation window size i.e., in a range is chosen e.g., from around 113 cm to 255 cm to eliminate both an early-time offset arising from a length of two RF cables and late-time reflections from one or more range bins outside the maximum distance covered by the imaging plane from the one or more antenna pairs 204A-N. Then the operating data matrix is M₂, of size 2m×n where any cell outside the window is set to 0. The data matrix is used to generate one or more object signature images through the VA-DMAS technique. After origin translation to the object frame of reference, an image creation is performed in a transverse plane of a target. The transverse plane is divided into a 51×51 grid in the cross-range and range directions, where each grid point is called a pixel. From the object frame of reference, the two pairs of antennas are virtually moving in a straight line with distance between successive positions being dx, where dx is calculated as follows:

Considering, the total length of motion (L) of any of the antenna pairs,

$$\\ \begin{matrix}dx = \frac{L}{m} & ( 1 )\end{matrix}$$

Each scan of M₂ corresponds to one or more successive virtual antenna positions, giving 2m values of dx. For a k^{th} scan (k=1, 2, . . . , 2m), projections of the first pair of transmit-receive (Tx-Rx 1) antenna positions on the transverse plane are denoted by the array of points (X₁, Y₁, Z₁) when k≤ m, and that of Tx-Rx 2 by the array (X₂, Y₂, Z₂) when k>m. Then, the combination of the two arrays to form the antenna position array (X, Y, Z). Mathematically, for Tx-Rx 1,

$$\\ \begin{matrix}\{ \begin{matrix}{X}_{1} ( k ) = k \cdot dx \\ {Y}_{1} ( k ) = 0 cm , k = 1 , 2 , … , m \\ {Z}_{1} = 9.5 cm\end{matrix} & ( 2 )\end{matrix}$$

Similarly for Tx-Rx 2,

$$\\ \begin{matrix}\{ \begin{matrix}{X}_{2} ( k ) = L + k \cdot dx - 12.5 cm \\ {Y}_{2} ( k ) = 46 cm \\ {Z}_{2} = 31 cm\end{matrix} , k = m + 1 , m + 2 , … , 2 m & ( 3 )\end{matrix}$$

Finally, for the combined data from the two antenna pairs, the array (X, Y, Z) is obtained as:

$$\\ \begin{matrix}\{ \begin{matrix}X = [ {X}_{1} , {X}_{2} ] \\ Y = [ {Y}_{1} , {Y}_{2} ] \\ Z = [ {Z}_{1} , {Z}_{2} ]\end{matrix} & ( 4 )\end{matrix}$$

Each pixel point is denoted as (xᵢ, yⱼ), i, j=1, 2, . . . , 51. The total intensity at each point is computed using the APW-DMAS technique to obtain the intensity matrix I(xᵢ, yⱼ) at coordinates (xᵢ, yⱼ). The round-trip distance of the pixel (xᵢ, yᵢ) from the k^{th} position is stored in the array dᵢⱼ, where,

$$\\ \begin{matrix}{d}_{i , j} ( k ) = 2 \sqrt{{( X ( k ) - {x}_{i} )}^{2} + {( Y ( k ) - {y}_{j} )}^{2} + {Z ( k )}^{2}} , & ( 5 )\end{matrix}$$

$$\\ i , j = 1 , 2 , … 51 , k = 1 , 2 , … 2 m$$

Each pixel makes a particular azimuth and elevation angle with each of the antenna positions. For incorporating the effect of the directive beams of the Vivaldi antennas into the image formation process, each of the antenna pairs are rotated at a particular angle with respect X, Y and Z axes, which is equivalent to an ordered series of rotations, one about each of the principal axes. These series of rotations are represented by a standard Euler rotation matrix [3], denoted by R, which uses the Euler angles of rotation—α, β and γ—of the object in an anti-clockwise direction about the X, Y and Z axes respectively. Then for each pixel point, the effective distances on the X, Y and Z axes, from each virtual antenna position is given by:

$$\\ \begin{matrix}\{ \begin{matrix}{d}_{{x}_{i}} ( k ) = R ( {x}_{i} - X ( k ) ) \\ {d}_{{y}_{j}} ( k ) = R ( {y}_{j} - Y ( k ) ) \\ {d}_{z} ( k ) = R ( Z ( k ) )\end{matrix} , i , j = 1 , 2 , … 51 , k = 1 , 2 , … 2 m & ( 6 )\end{matrix}$$

For k<=m, an Euler angles is utilized for Tx-Rx 1 and for k>m, the Euler angles for Tx-Rx 2 are used in calculating the matrix R. The 2m number of distances is converted for each pixel into the spherical coordinate system (r, ϕ(k), (k)). Then, ϕ(k) and θ(k) angle values are correlated to the respective azimuth and elevation radiation patterns at 4 GHz. The normalized radiation pattern magnitudes are considered on a linear scale. The normalized patterns are further filtered by a 361-point (−180° to +180°) hamming window centered around the peak gain position to suppress the side lobes. For each of the azimuth and elevation angles, the corresponding realized gain values are taken from their respective normalized and filtered patterns in linear scale. Then the product of these two normalized values, and the product provides the pattern factor (PF). For each pixel point, PF_{i,j} forms a 1×2m array, with the multiplier value PF_{i,j} (k) for the k^{th} position.

Using the 2m virtual antenna position, a contribution of all scans is obtained towards a given pixel through linear interpolation with a time-of-flight calculation for a given pixel location (xᵢ, yᵢ) from virtual antenna positions (X, Y, Z). The pixel contribution from the k^{th} virtual antenna position for each pixel is termed as pc_{i,j}(k), thus forming the array pc_{i,j} of length 2m that stores all the contributions to the intensity value of that pixel form all scans. The total intensity at the pixel (xᵢ, y) is a sum of the weighted pairwise products of pixel contribution from all the k scans, where PF_{i,j} functions as the individual weights. This leads to synthetic focusing of the pixels of the one or more object signature images which are directly covered by the main beam. The total intensity is given by Eqn. (7).

$$\\ \begin{matrix}I ( {x}_{i} , {y}_{j} ) = \frac{1}{2} {\sum }_{k , k ′ = 1}^{2 m} {pc}_{i , j} ( k ) \cdot {PF}_{i , j} ( k ) \cdot {pc}_{i , j} ( {k}^{{}_{} ′} ) \cdot {PF}_{i , j} ( {k}^{{}_{} ′} ) , k \neq {k}^{{}_{} ′} & ( 7 )\end{matrix}$$

Equations 1 to 7 are calculated for all the other pixels to obtain the one or more object signature images. In an embodiment, one or more features associated with the one or more object signature images are extracted. A trained classification model is obtained based on one or more features associated with the one or more object signature images. The trained classification model identifies the class of each object under test from among one or more object under test moving on the conveyor 208. A confidence score for an unknown test object is obtained from the trained classification model to recognize if there is a false alarm raised when the object under test is classified. In an embodiment, the confidence score is provided by a voting process, in-built into the classifier (e.g., random forest) used. The calculation of this confidence score changes according to the machine-learning classifier used.

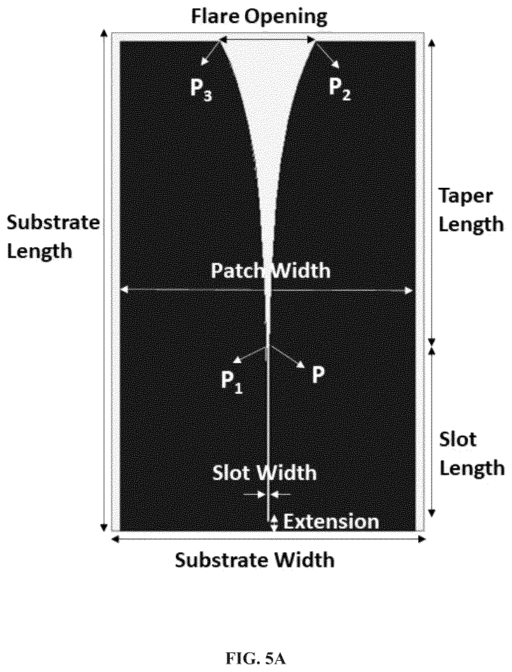

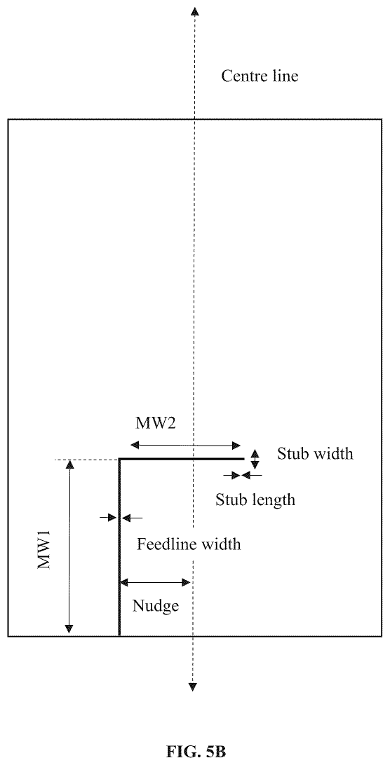

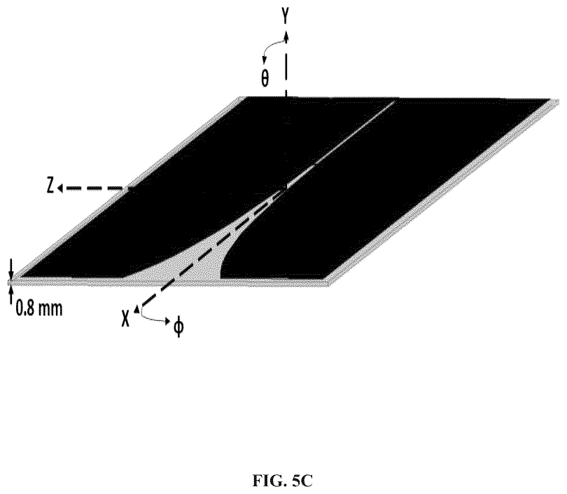

FIG. 5A is a top view of the exemplary broadband coplanar Vivaldi antenna, according to an embodiment of the present disclosure. FIG. 5B is a bottom view showing a feedline of the exemplary broadband coplanar Vivaldi antenna, according to an embodiment of the present disclosure. FIG. 5C is a three-dimensional (3D) view showing a substrate height, three dimensional (X, Y, Z) axes, and reference angles (i.e., θ and ϕ) of the exemplary broadband coplanar Vivaldi antenna respectively, according to an embodiment of the present disclosure. The antennas designed for the system 200 are broadband coplanar Vivaldi antennas, which includes a radiating copper patch in which a slot-line with flared aperture is cut, on top of FR4 (εᵣ=4.4) substrate of thickness 0.8 mm. The size of the substrate is 140 mm×90 mm, designed for the 3 GHZ-4.7 GHZ frequency band, centered at 4 GHz. The antenna is fed by an L-shaped microstrip feedline, present on bottom surface of the surface, which ends in a rectangular stub whose length and width are optimized for broadband impedance matching. The antenna is fed through an SMA connector soldered to the other end of the feedline. The antenna design, with the design parameters. The optimized values of the parameters the Vivaldi antennas are provided in below table 1:

TABLE 1

| Design Parameters | Value (mm) |
|---|---|
| Substrate Length | 140 |
| Substrate Width | 90 |
| Substrate Thickness | 0.8 |
| Patch Width | 85 |
| Flare Opening | 27.75 |
| Flare Opening Rate (R) | 38 |
| Slot Length | 45 |
| Slot Width | 0.9 |
| Taper Length | 90 |
| MW1 | 48.05 |
| MW2 | 31.15 |
| Stub Length | 1.5 |
| Stub Width | 3 |
| Feedline Width | 1.1 |
| Nudge | 18.6 |
| Extension | 2.5 |

The slot-line to free space transition is governed by a flare opening of the slot-line. An exponential taper profile is defined by an opening rate (R) and the flare starting coordinates P and P′ and the flare end-point coordinates P1 and P2 (P, P′, P1 and P2.

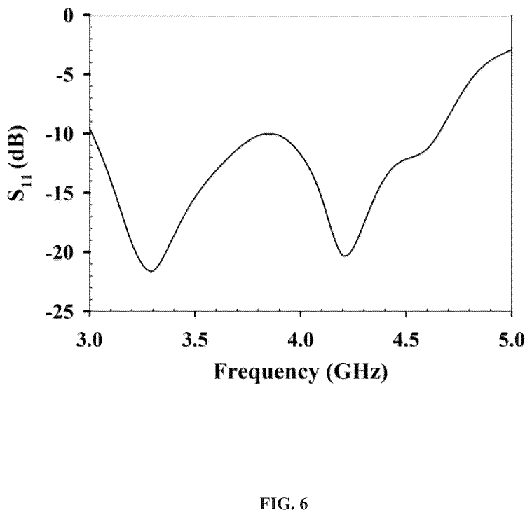

FIG. 6 is an exemplary graphical representation depicting a simulated return loss of the Vivaldi antenna, according to an embodiment of the present disclosure. The simulated return loss characteristics of the Vivaldi antenna, a |S₁₁| value remains below −10 dB from 3 GHz to 4.7 GHZ (e.g., impedance bandwidth=1.7 GHZ), with two resonance points at 3.3 GHZ and 4.2 GHz.

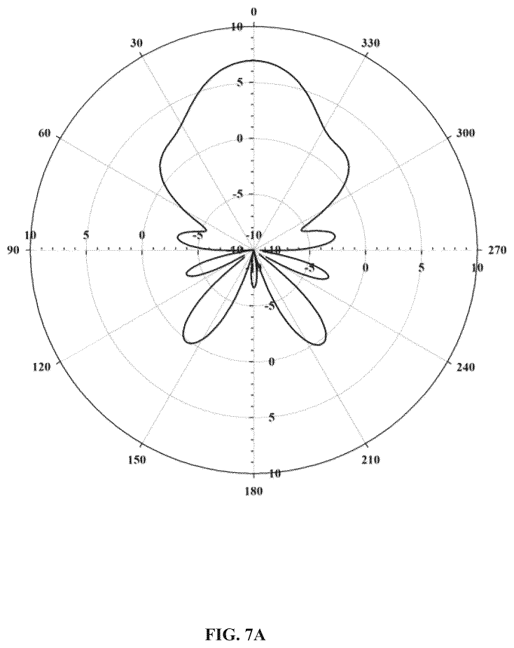

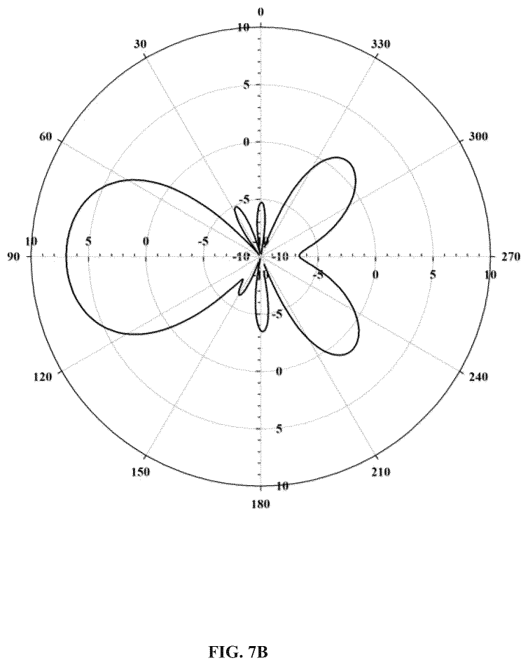

FIG. 7A is an exemplary graphical representation depicting a simulated radiation pattern of the Vivaldi antenna at 4 GHz and azimuth (X-Z plane) varying with ϕ respectively, according to an embodiment of the present disclosure. FIG. 7B is an exemplary graphical representation depicting a simulated radiation pattern of the Vivaldi antenna at 4 GHz and Elevation (X-Y plane) varying with θ respectively, according to an embodiment of the present disclosure. The Vivaldi antenna radiates towards the flare opening, i.e., the main beam is in the direction of ϕ=0°, θ=90° in the X-Z plane. The simulated azimuth (X-Z plane) and the elevation (X-Y plane) radiation patterns at 4 GHz are shown. The respective 3 dB-beamwidths are 46.85° and 56.5°, with a peak gain of 6.93 dBi at 4 GHz.

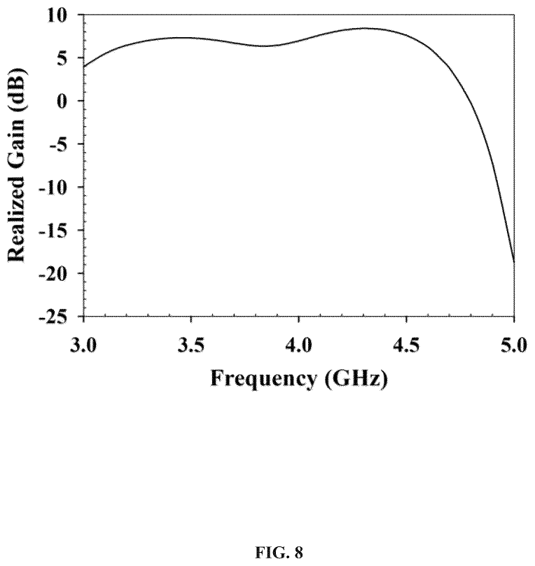

FIG. 8 is an exemplary graphical representation depicting a simulated realized gain against a frequency of the Vivaldi antenna, according to an embodiment of the present disclosure. The variation of the simulated peak realized gain in the azimuth plane with frequency is shown. The gain curve remains relatively flat from 3.1 GHz to 4.7 GHz, with the maximum gain at 8.4 dBi at 4.3 GHZ. The −3 dB-gain bandwidth is from 3.09 GHz to 4.63 GHz. The design parameters of the antenna have been optimized such that |S₁₁| remains below −10 dB over a wide operating range, and the realized gain (dB) remains relatively flat with high values over the operating range.

### Experimental Results

For example, a study is conducted to detect objects in the sealed packages based on the virtual antenna-based delay-multiply-and-sum (VA-DMAS). The experiment was conducted using a PulsON 440 (P440) module, a UWB radio transceiver operating in the 3.1 GHZ to 4.8 GHz frequency band in monostatic mode. The radar unit requires separate transmitter and receiver antennas. A highly-directive coplanar Vivaldi antenna is designed to cover the radar's operating frequency band and utilize two as transmitters and two as receivers. The configuration parameters of the radar module are controlled by corresponding graphical user interface (GUI). Range resolution for the module is 0.0091 m. The one or more configuration parameters of the radar are listed in Table 2.

TABLE 2

| Maximum | Pulse | Transmit power | Scan |
|---|---|---|---|
| Range under | Integration | delivered | Interval |
| consideration (m) | Index (PII) | (dBm) | (msec) |
| 0.88 × 3 = 2.64 | 15 | −31.6 | 84 |

The experimental setup includes a P440 radar module, connected through two RF switches and four 2 ft.-long RF cables to the four coplanar Vivaldi, an Arduino UNO board, and one 1.87 m-long conveyor. The Arduino board is used to control the RF switches. The OUT, i.e., the unopened package and corresponding contents, which are the target of in-box imaging, are moving on the conveyor belt towards the zone between the antenna pairs. The moving speed of the conveyor belt is set to around 11 cm/sec. The radar module is kept at a suitable height to facilitate the arrangement of the two sets of antennas (Tx-Rx 1 and Tx-Rx 2) on both the sides of the conveyor belt. The packages under investigation move on the belt towards the zone on the belt that is within line-of-sight and covered by the beam span of the two antenna pairs. The two sets of antennas are connected to the radar module through two 2:1 RF switches. The specifications of the RF Switches are given in Table 3.

TABLE 3

| | | Insertion | Isola- | Return Loss | Return Loss |
|---|---|---|---|---|---|
| | Operating | Loss @ | tion @ | “ON” | “OFF” |
| | Frequency | 4 GHz | 4 GHz | State | State |
| Type | Range | (dB) | (dB) | (dB) | (dB) |
| Non- | DC-6 GHz | 1.4 | 44 | 9 | 18 |
| Reflective | | | | | |

The X, Y and Z axes, along with the origin point (i.e., at the base of the Tx-Rx 1 pair of antennas) are marked. According to the coordinate system, Tx-Rx 1 is at (0, 0, 9.5 cm) position, while Tx-Rx 2 is at (−12.5 cm, 46 cm, 31 cm). The distances are measured from the phase center of the transmitter-receiver pair. The two antenna pairs look at the top of the conveyor belt at an angle with the Y-axis, that ensures greater coverage of the belt surface with the conical beamwidth of the antennas, thus giving a wider view of the incoming package. The reason for such an arrangement is that only one pair of antennas is not sufficient to obtain a full 360° view of the moving package since they can only detect a certain sectoral view of the package. Hence, the two pairs of antennas on two sides of the conveyor belt are considered to obtain the full view, and Tx-Rx 2 is also kept looking down from a height of 31 cm to obtain a consolidated three-dimensional view of the package. Then the Euler angles of anti-clockwise rotation of the antennas about the X, Y and Z axes respectively, for Tx-Rx 1, are α₁=0, β₁=0, γ₁=−22.57° and for Tx-Rx 2, α₂=0, β₂=−33.61°, γ₂=31.72° (i.e., considering the negative of the actual rotation angle of the antenna to calculate effective rotation from the perspective of the imaging plane). The exact coordinates of the two antenna pairs have been decided on an empirical basis after many experiments on optimizing the view angles of the antennas. For applying the VA-DMAS technique, the relevant area under consideration is 0 to 125 cm in the X-direction and 10 cm to 44 cm in the Y-direction.

For example, an optical camera is set up that looks at the top of the conveyor belt from a height, and the camera view is continuously processed to keep track of any color changes. Once the package crosses a predetermined boundary line, the camera captures the large color change as compared to the uniformly colored belt surface, and automatically sends a signal so that the radar scanning is triggered. The RF switches provide a communication path from the ports of the radar module to the antennas. First, the Arduino drives the two switches such that they can transmit and receive signals through the Tx-Rx 1 antennas. Then, the radar is configured to complete 20 scans using the parameters highlighted in Table 2. Then the two switches start communicating through the Tx-Rx 2 pair of antennas. Again, 20 scans are completed in the same manner, giving a total of 2m=40 scans. The scans are further processed and the virtual antenna-based delay-multiply-and-sum (VA-DMAS) technique is applied, after which an image is formed. Based on the images obtained from 210 datasets on different objects, a machine-learning based classification is implemented to determine which class any unknown package under test falls into, where the classes are defined based on one or more use-cases. The boxes containing the objects were chosen at random with respect to their size (i.e., between 15 cm to 20 cm in length and 6 cm to 12 cm in height) and shape. Also, the placement orientations of the boxes on the conveyor belt and that of the objects inside the boxes were randomly varied at different instances of data collection.

The contents of the packages used in the experiment are separated but not limited to three classes: (a) Class 0: Empty i.e., refers to different empty packages of varying size and shape or packages containing non-battery objects like clothes, packaging material, mobile phone with in-built battery etc. (b) Class 1: Laptop battery i.e., refers to different packages containing a single laptop battery (Li-ion) which is larger in size and of different shape from the batteries in Class 2. This class is included as a benchmark of whether a loose Li-ion battery is detected even with the drastic change in size and shape, and (c) Class 2: Li-ion battery i.e., refers to different packages containing several loosely packed small Li-ion batteries stacked together.

The VA-DMAS technique in combination with the PF generates visibly distinct image matrices and can be directly used for discrimination amongst the classes specified earlier. However, for a limited number of objects in the imaging plane, these matrices are typically sparse in nature. To mitigate this effect, a two-directional two-dimensional principal component analysis (2D2D-PCA) transformation on the produced DAS images to yield relevant features that are subsequently used for classification and justify the discriminatory nature of this representation. The 2D2D-PCA maximizes the generalized total scatter criterion, and therefore extracts information from rows as well as columns from the formed image. The output of 2D2D-PCA is then vectorized and used as features. A combination of top k features along the optimal projection axes as generated by the 2D2D-PCA process is selected, flattened, and passed on to a classifier for distinction between separate classes. After performing 2D2D-PCA, only initial dominant eigenvalues (2 in row direction and 5 in column direction) are selected that leads to 2×5 output matrix in terms of size. Thus overall, 10 features are used after vectorization. Hence, from 51×51 image size are extracted and use only 10 features thereby avoiding overfitting.

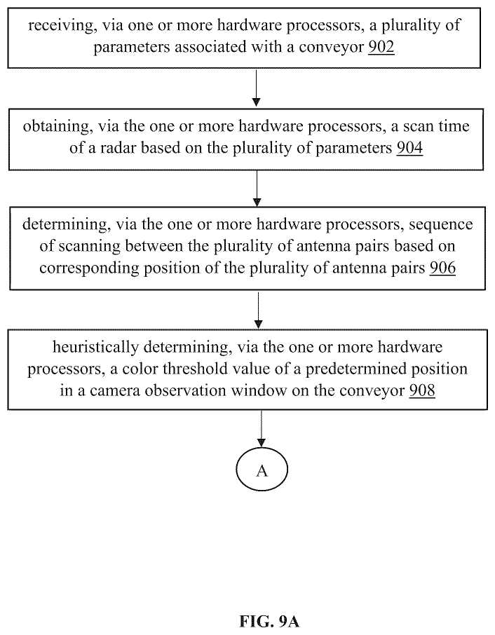

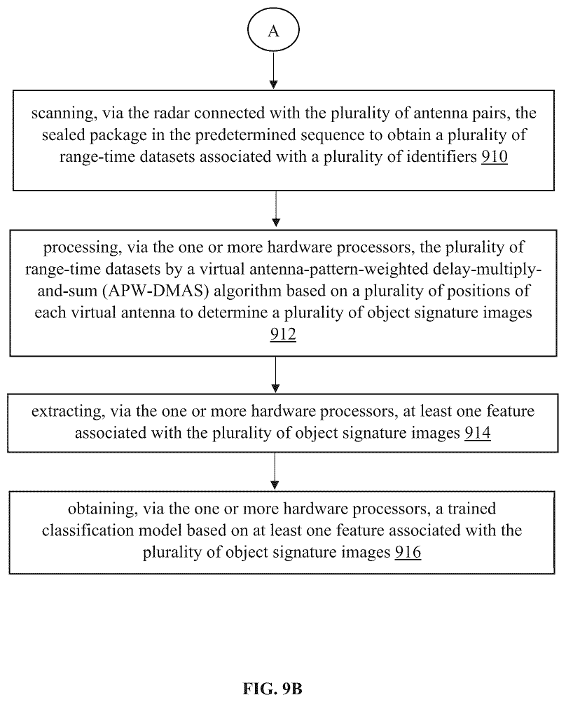

FIG. 9A and FIG. 9B are flow diagrams illustrating a method of detecting one or more objects in one or more sealed packages based on the virtual antenna-based delay-multiply-and-sum (VA-DMAS), according to an embodiment of the present disclosure. In an embodiment, the system 100 comprises one or more data storage devices or the memory 104 operatively coupled to the one or more hardware processors 102 and is configured to store instructions for execution of steps of the method by the one or more processors 102. The flow diagram depicted is better understood by way of following explanation/description. The steps of the method of the present disclosure will now be explained with reference to the components of the system as depicted in FIGS. 1 and 2.

At step 902, one or more parameters associated with the conveyor 208 are received. In an embodiment, the one or more parameters corresponds to: (i) speed of the conveyor 208, (ii) length (L) of the conveyor 208 available for imaging that is determined from a position and a beamwidth of the one or more antenna pairs 204A-N, and (iii) number of scans (M). At step 904, a scan time of the radar 202 is obtained based on the one or more parameters. The scan time is divided into equal parts for each antenna pair (Tx-Rx) from the one or more antenna pairs 204A-N. Time interval between each scan is determined based on the scan time of the radar 202. At step 906, a sequence of scanning between the one or more antenna pairs 204A-N is determined based on corresponding position of the one or more antenna pairs 204A-N. At step 908, a color threshold value of a predetermined position is heuristically determined in a camera observation window on the conveyor. If the color threshold value is exceeded as front end of an object under test packed inside the sealed package 210A crosses the predetermined position on the conveyor, and scanning is triggered. The color threshold value corresponds to one or more RGB values. At step 910, the sealed package in the predetermined sequence is scanned by the radar 202 connected with the one or more antenna pairs 204A-N to obtain one or more range-time datasets associated with one or more identifiers. The one or more range-time datasets correspond to one or more reflected signals from the object 206 under test having continuous motion on the conveyer. In an embodiment, the one or more range-time datasets corresponds to a form of a two-dimensional matrix, where the rows are the scans at each time instant, and the columns are the range bins. At step 912, the one or more range-time datasets are processed by a virtual antenna-pattern-weighted delay-multiply-and-sum (APW-DMAS) technique based on one or more positions of each virtual antenna to determine one or more object signature images. In an embodiment, the one or more object signature images is determined by a pattern factor derived based on a radiation pattern from the one or more antenna pairs 204A-N. In an embodiment, the pattern factor corresponds to a synthetic weight factor that heuristically incorporates directivity and gain of each antenna. At step 914, one or more features associated with the plurality of object signature images are extracted. At step 916, a trained classification model is obtained based on the one or more features associated with the one or more object signature images. The trained classification model identifies the class of each object under test from among one or more object under test moving on the conveyor 208. A confidence score for an unknown test object is obtained from the trained classification model to recognize if there is a false alarm raised when the object under test is classified.

In an exemplary embodiment, below mentioned is an exemplary pseudo code for the above-mentioned method steps involved in detecting one or more objects in one or more sealed packages based on the virtual antenna-based delay-multiply-and-sum (VA-DMAS) is described herein. The code is meant to generate an image of the target object, in a horizontal plane, from the radar data, by applying a DMAS method with virtual antenna positions and incorporating the antenna pattern factor (PF) for improving image quality. DATA INPUT: Reflection data from the object that is captured by the radar 202, which is in the form of a 2m×n range-time matrix, M. Apply preprocessing steps and motion filter on M, to obtain the matrix M₂. Consider, as constants the conveyor belt speed, number of radar scans, interval time between scans, real antenna positions, the angles made by the antennas with respect to the fixed X, Y, and Z axes, the size and position of imaging plane relative to antenna positions in terms of X, Y, Z coordinates and the number of row and column pixels i.e., called as cross-range and range pixels respectively, that the imaging plane is divided. Generate the virtual antenna positions based on the speed of the belt, number of scans and scan interval, where each scan in M₂ indicates a virtual antenna position. The first m scans correspond to the virtual antenna positions of the first antenna pair and the last m scans correspond to the virtual positions of the second antenna pair.
FOR i from 1 to No. of cross-range pixels
   FOR j from 1 to No. of range pixels
      FOR k from 1 to No. of scans
         Calculate the distance of each pixel i, j (i.e., from their X, Y, Z coordinates (xᵢ, yⱼ, z)) from each of the virtual antenna positions->d_{i,j}(k), where k is the scan number.
         Find the range bin in k^{th} scan of M₂ which corresponds to d_{i,j}(k).
         If the distance dᵢⱼ(k) is not an integer then find the intensities of the two range bins closest to the distance.
         Take the weighted mean of the two intensities, through linear interpolation from time-of-flight calculation, as the contribution to the pixel i,j from the k^{th} scan.
         Take into consideration the angles made by the antennas with the X, Y and Z axes by rotating each antenna pair at a particular angle with respect X, Y and Z axes, which is equivalent to an ordered series of rotations, one about each of the principal axes, represented by a standard Euler rotation matrix.
         The effective distance of each pixel i,j from each virtual position on the X, Y and Z axes is obtained after this rotation->dₓᵢ(k), d_{yj}(k), d_{z}(k).
         For the first m virtual positions, dₓᵢ(k), d_{yj}(k), d_{z}(k) are obtained by rotation corresponding to the angle of the first antenna pair, while for the last m scans, the dₓᵢ(k), d_{yj}(k), d_{z}(k) are obtained from the rotation of the second antenna pair.
         From these distances, calculate the azimuth and elevation angles between the pixel position (xᵢ, yⱼ, z) and the antenna position.
         Correspond the above angles to the normalized and filtered radiation patterns (i.e., in linear scale) of the antenna in azimuth and elevation planes and find the normalized gain values at those angles.
         Take the product of these respective gain values to form the pattern factor (PF_{i,j}) that act as weights for synthetic focusing of the image.
         Calculate total intensity at the pixel i,j as the sum of the weighted pairwise products of pixel contribution from all the k scans, where PF_{i,j} functions as the individual weights->I(xᵢ, yᵢ).
         Normalize the final image with respect to corresponding maximum intensity value.
         Display the image in the imaging plane.

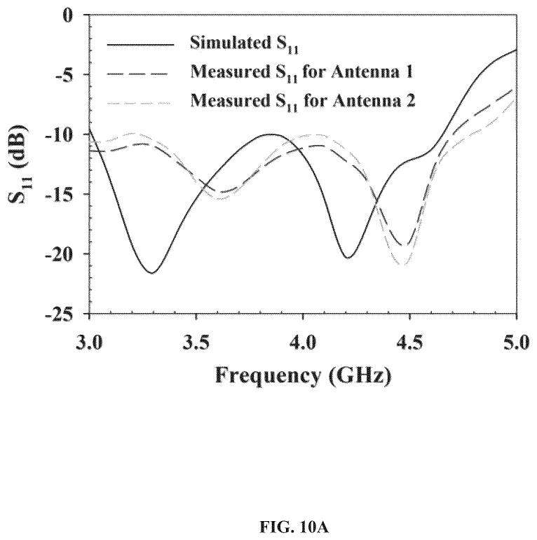

FIG. 10A and FIG. 10B are exemplary graphical representations depicting a simulated and measured (a) return losses of two antennas, and (b) realized gain vs Frequency of the Vivaldi antenna respectively, according to an embodiment of the present disclosure. The simulated and measured results (for two antennas) are shown that the measured |S₁₁| has a good agreement with the simulated results in terms of overall curve shape and bandwidth, only with a 300 MHz deviation of the resonance points towards higher frequencies compared to the simulated results. The measured return losses of the two antennas are also in good agreement with each other, thus showing consistent results. Also, the measured gain vs frequency curve shows good agreement with the simulated result.

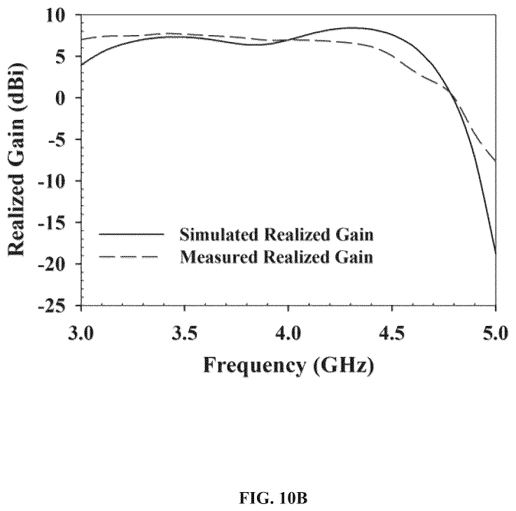

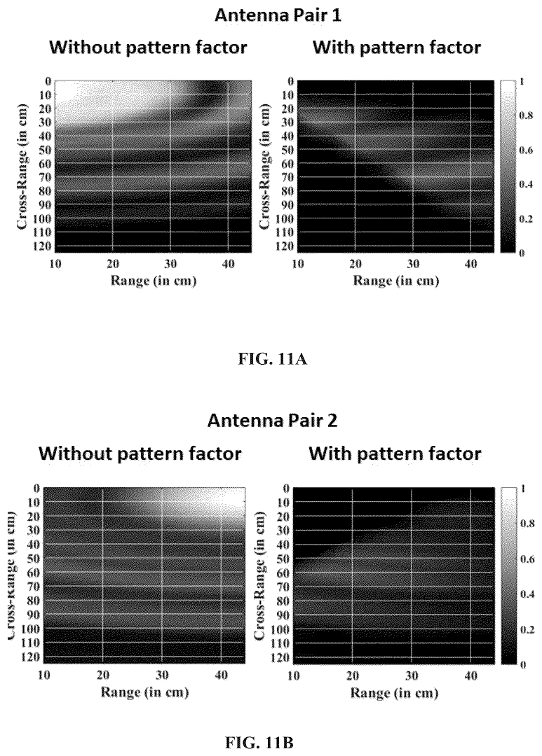

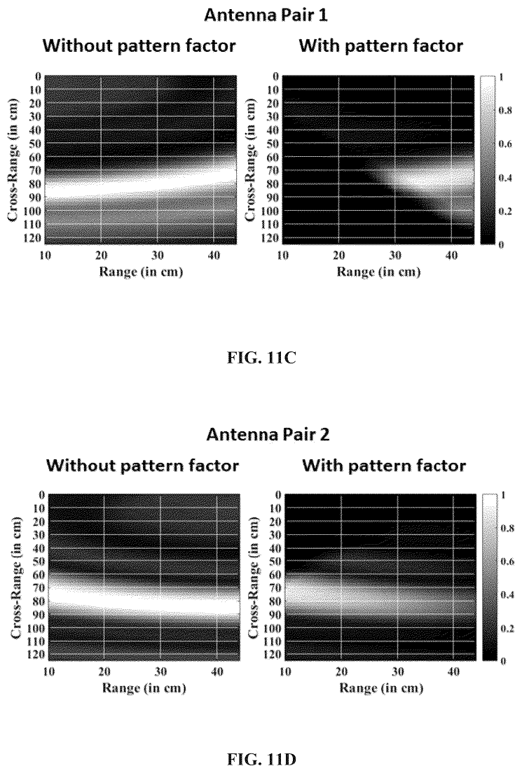

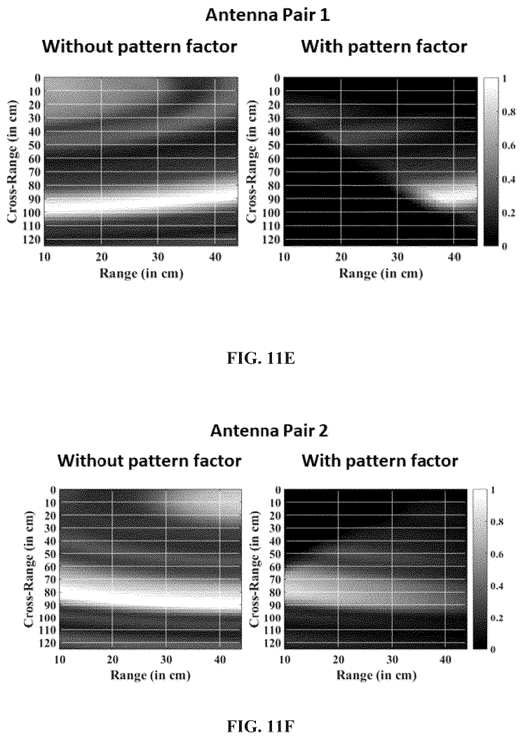

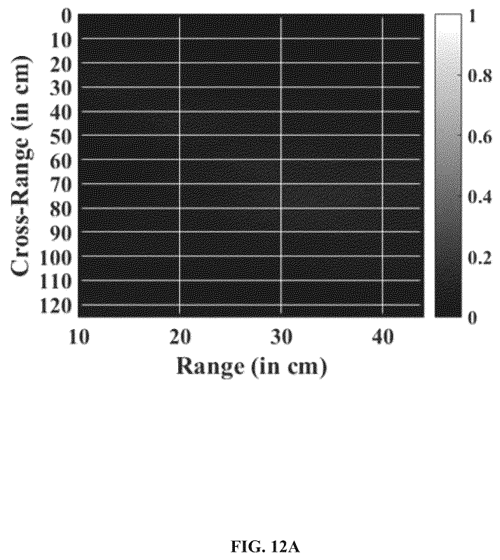

FIG. 11A to FIG. 11F are exemplary graphical representations depicting one or more images obtained by the VA-DMAS from the viewpoints of Tx-Rx1 and Tx-Rx 2, without and with pattern factor, for a representative dataset of: (a) empty box, (b) box containing laptop battery, and (c) box containing a stack of Li-ion batteries respectively, according to an embodiment of the present disclosure. In the observation window of the range-time data, the VA-DMAS technique is applied to obtain the images of the OUT i.e., where the OUT is a representative example of an empty box, a box containing laptop battery and a box containing a stack of Li-ion batteries, in that successive order respectively. The individual range-cross range image, from the data of one representative example of each class of OUT, as obtained from the viewpoint of each of the two Tx-Rx pairs, as well as a comparison between the images obtained without and with incorporating the PF from each of the antenna pairs. The images obtained by one Tx-Rx pair are normalized, where the normalization factor is the peak intensity of the image without PF, and this factor is used to normalized both the image without PF and with PF. Similar process is followed for the images obtained by the other Tx-Rx pair which are normalized by the peak intensity of the image without PF formed by it. This is repeated for the images of each OUT for each Tx-Rx pair.

The PF provides a drastic effect on the generated images by reducing noise and unwanted artifacts by a large extent. Tx-Rx 1 is located at (0,0) and Tx-Rx 2 is located at (46, −12.5 cm) of the imaging plane. For the empty box, there is a large region of high intensity near the two antenna locations, which are indicative of noise and unwanted reflections, and this is evident from the fact that after multiplying with PF, these noise regions get suppressed and their intensities are reduced from 0.9-1 to 0.4-0.5. On the other hand, for the case of the box containing batteries, there is a high intensity band that is located far from the antenna positions in the imaging plane, which is spread out over all ranges due to undesired noise signals, and after multiplying with the PF, the spread gets reduced to a large extent till there is only a small core region of high intensity near the actual object location on the conveyor belt from 30 cm to 40 cm approximately. There is still some spread in the range and cross-range directions, which can be attributed to the fact that the elevation beamwidth of the antenna influences this horizontal cross-section image.

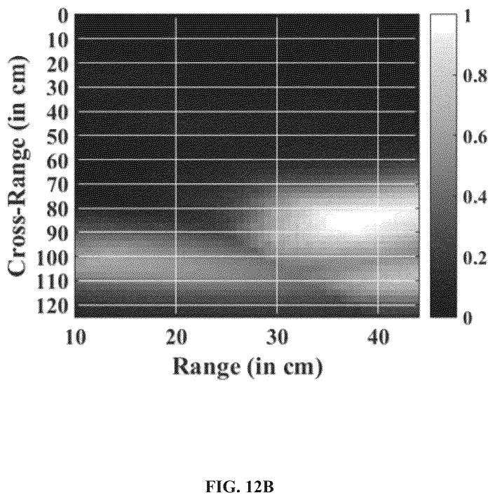

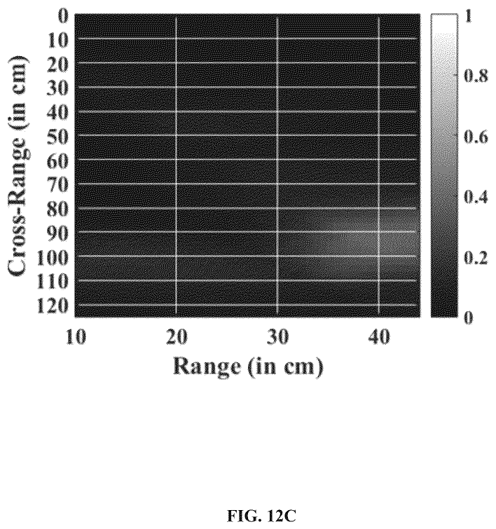

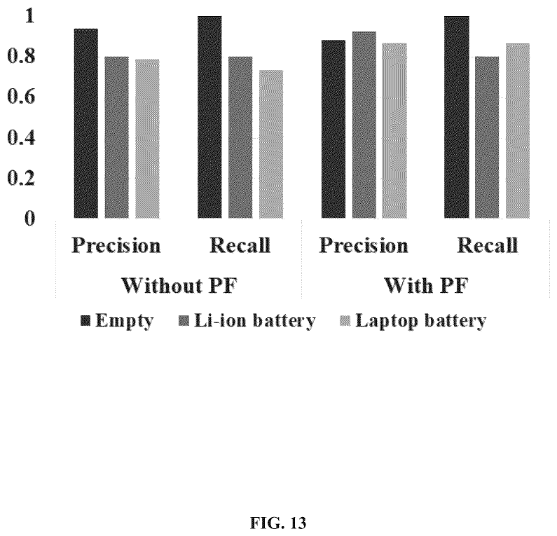

FIG. 12A to FIG. 12C are exemplary graphical representations depicting one or more images obtained by the VA-DMAS from the combined view, with the pattern factor, for a representative dataset of: (a) empty box, (b) box containing laptop battery, and (c) box containing a stack of Li-ion batteries respectively, according to an embodiment of the present disclosure. The images have been normalized with respect to the peak intensity value of (b). The chosen datasets of each class of the OUT, the combined view of the two antenna pairs is displayed, where the pattern factors have been incorporated. Here, the three images are normalized with respect to the peak intensity value of the combined view image of the laptop battery since corresponding highest peak intensity of the three objects which shows that the final actual image formed using the VA-DMAS and the PF, have the object location (i.e., indicated by the high intensity zones) very near to their real positions in the experiment and the empty box image is almost at zero intensity at all pixels. The relative intensity differences of the three classes of OUT are demonstrated, which is nearly consistent over all the datasets collected for all the classes. The relative differences in the images as shown in FIG. 13 act as a strong basis of discrimination between the classes.

The feature vector obtained by performing the 2D2D-PCA on the DAS images for all cases was arranged in various training and testing sets. There are a total of 70 data instances per class, and hence a total of 210 instances for all classes. A random 165:45 split of the data is performed for training and testing, while maintaining an equal representation for each class in each of the sets. The feature performance of four classifiers is compared using the 2D2D-PCA features are as mentioned in Table 4, where the role played by the PF in generating a better representation in the imaging plane are evaluated.

TABLE 4

| Classifier | Accuracy without PF | Accuracy with PF |
|---|---|---|
| kNN with 3 neighbors | 78.7% | 85.2% |
| kNN with 5 neighbors | 71.2% | 79.4% |
| SVM with Linear Kernel | 79% | 81.3% |
| SVM with Radial Basis | 71.3% | 83.3% |
| Function (RBF) Kernel | | |
| Bagged Decision Tree | 81.7% | 86.9% |
| Random Forest | 81.6% | 87.5% |

The ensemble classifiers generally perform well on the 2D2D-PCA features as compared to the kNN (k Nearest Neighbors) and SVM (Support Vector Machine) classifiers, even when the PF is not included in the VA-DMAS image before computation of the feature vector. This is because ensemble methods generally discourage overfitting and work well for smaller datasets. All the classifiers perform markedly better after incorporation of the PF in the VA-DMAS image, with an average in accuracy of 7.5%. Therefore, Table 4 provides conclusive justification for the proposed methodology and the usefulness of the PF. Similarly, kNN, SVM, Bagged Tree and Random Forest classifiers were compared. The Random Forest classifier shows the best performance when considering the 5-fold cross-validation accuracy during training. Hence, testing on unseen data is performed only for the same classifier. The testing accuracy on unseen data was 82.4% and 88.9% when the PF was omitted and used in the VA-DMAS image respectively. The testing accuracy is slightly higher than the training accuracy and may occur when the model acts as an excellent predictor and has learnt the boundary cases well. Also, when the validation data, although selected randomly, ends up having less complexity.

FIG. 13 is an exemplary graphical representation depicting precision and recall values for different classes using the Random Forest classifier, according to an embodiment of the present disclosure. Apart from accuracy, specific precision and recall values for each class are also important in characterizing a classifier. The maximum recall values are always obtained for the empty box class. The minimum precision and recall values for all classes are increased when the PF is included. Moreover, the variance in precision and recall between classes is also reduced substantially when the PF is used. The average values of precision and recall when the PF is used are 0.89 (standard deviation=±0.02) and 0.89 (standard deviation=±0.1) respectively.

The embodiment of the present disclosure herein addresses the unresolved problem of detecting objects in the sealed packages. The embodiment of the present disclosure provides an approach of detecting objects in sealed packages based on machine learning-driven radar imaging. The embodiment of the present disclosure utilizes an UWB radar with pulsed signal, with two sets of Tx-Rx antennas connected to a single radar module, arranged on both sides of the conveyor belt at different elevation planes to automatically collect the 3D data of the package. The object type is decided purely based on the images obtained from the radar data, on which machine learning classifier is trained to detect the undesired objects, and this classifier can then automatically characterize the contents of the unknown test object. Radar Imaging is the main process of object detection and identification. Furthermore, no bulky metal detector structure is required, nor is a large array of radar-antenna sub-systems, thus increasing the portability and lowering the cost of the system. The embodiment thus improves the image distinctiveness thereby the detection accuracy is increased to 88.9% from 82.4% when the antenna pattern is not considered in computation and after incorporating the antenna pattern for calculating the synthetic weights, in the form of the pattern factor (PF) in the VA-DMAS technique. The high directivity coplanar Vivaldi antennas are fabricated, and the whole radar system is implemented. The beamwidth is narrow-provide better resolution of the images formed. From the obtained VA-DMAS images, after introduction of the PF, the image quality and accuracy have drastically improved compared to the case without the PF. Virtual Antenna Positions and higher reflectivity obtained because of motion of object i.e., occluded is not obvious. Also, the method of adjusting scan interval based on velocity of object in motion, and the heuristic method of ascertaining the antenna positions and orientations is performed based on the knowledge of working in this domain.

The embodiment of the present disclosure mitigates ambiguity by using the antenna pattern which is not obvious. Another point of difference in the VA-DMAS technique from the standard delay-and-sum (DAS) or DMAS techniques lies in the fact that VA-DMAS technique is meant to work in a linear setup, i.e., when the target object is moving in a straight line with a certain speed on a conveyor belt through the observation zones of the radar antennas. The APW-DMAS technique is utilized to create an image of the object from the radar return data. Then, the features are extracted from each image of each known object, using a 2D2D-PCA technique, where the input data are the intensity values of the image pixels and no conversion to frequency domain is required. Finally, training a classifier based on these features and use the classifier model to automatically detect the type of unknown object in the sealed package. The embodiment of the present disclosure utilizes only two pairs of Tx-Rx antennas to observe the object moving in a straight line in between their respective positions. One of the antenna pairs is in the same plane as the object on the conveyor belt, while the other was looking down at the object from an elevated plane. The two antenna pairs obtain a view of the object from the front end left sides and from the top, front, and right sides respectively. Thus, providing a good approximation of the object's position and size. Also, the antennas are not operated simultaneously, rather they are switched on one at a time in a sequential order, thus collecting data of the object at different time instances and thus different positions on the conveyor belt. Moreover, the concept of Virtual antenna introduced in, which is useful for this sort of Inverse SAR imaging scenario. The PF is applied by which the image becomes far more refined with a core elliptical region of high intensity at the expected object position with a diffraction halo in all directions that taper off over a small range. Therefore, the introduction of the PF causes a drastic change in the quality, accuracy, and resolution of the images.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
receiving, via one or more hardware processors, a plurality of parameters associated with a conveyor;
obtaining, via the one or more hardware processors, a scan time of a radar based on the plurality of parameters, wherein the scan time is divided into equal parts for each antenna pair (Tx-Rx) from a plurality of antenna pairs, wherein time interval between each scan is determined based on the scan time of the radar;
determining, via the one or more hardware processors, sequence of scanning between the plurality of antenna pairs based on corresponding position of the plurality of antenna pairs;
heuristically determining, via the one or more hardware processors, a color threshold value of a predetermined position in a camera observation window on the conveyor, wherein if the color threshold value is exceeded as front end of an object under test packed inside a sealed package crosses the predetermined position on the conveyor, and scanning is triggered, and wherein the color threshold value corresponds to a plurality of RGB values;
scanning, via the radar connected with the plurality of antenna pairs, the sealed package in the predetermined sequence to obtain a plurality of range-time datasets associated with a plurality of identifiers, wherein the plurality of range-time datasets corresponds to a plurality of reflected signals from the object under test having continuous motion on the conveyer;
processing, via the one or more hardware processors, the plurality of range-time datasets by a virtual antenna-pattern-weighted delay-multiply-and-sum (APW-DMAS) technique based on a plurality of positions of each virtual antenna to determine a plurality of object signature images;
extracting, via the one or more hardware processors, at least one feature associated with the plurality of object signature images; and
obtaining, via the one or more hardware processors, a trained classification model based on at least one feature associated with the plurality of object signature images, wherein the trained classification model identifies class of each object under test from among a plurality of object under test moving on the conveyor.

2. The processor implemented method of claim 1, wherein the plurality of parameters corresponds to: (i) speed of the conveyor, (ii) length (L) of the conveyor available for imaging that is determined from a position and a beamwidth of the plurality of antenna pairs, and (iii) number of scans (M).

3. The processor implemented method of claim 1, wherein the plurality of range-time datasets corresponds to a form of a two-dimensional matrix, where the rows are the scans at each time instant, and the columns are the range bins.

4. The processor implemented method of claim 1, wherein the plurality of object signature images is determined by a pattern factor derived based on a radiation pattern from the plurality of antenna pairs, and wherein the pattern factor corresponds to a synthetic weight factor that heuristically incorporates directivity and gain of each antenna.

5. The processor implemented method of claim 1, wherein a confidence score for an unknown test object is obtained from the trained classification model to recognize if there is a false alarm raised when the object under test is classified.

6. A system, comprising:
a memory storing instructions;
one or more communication interfaces; and
one or more hardware processors coupled to the memory via the one or more communication interfaces, wherein the one or more hardware processors are configured by the instructions to:
receive, a plurality of parameters associated with a conveyor;
obtain, a scan time of a radar based on the plurality of parameters, wherein the scan time is divided into equal parts for each antenna pair (Tx-Rx) from a plurality of antenna pairs, wherein time interval between each scan is determined based on the scan time of the radar;
determine, sequence of scanning between the plurality of antenna pairs based on corresponding position of the plurality of antenna pairs;
heuristically determine, a color threshold value of a predetermined position in a camera observation window on the conveyor, wherein if the color threshold value is exceeded as front end of an object under test packed inside a sealed package crosses the predetermined position on the conveyor, and scanning is triggered, and wherein the color threshold value corresponds to a plurality of RGB values;
scan, via the radar connected with the plurality of antenna pairs, the sealed package in the predetermined sequence to obtain a plurality of range-time datasets associated with a plurality of identifiers, wherein the plurality of range-time datasets corresponds to a plurality of reflected signals from the object under test having continuous motion on the conveyer;
process, the plurality of range-time datasets by a virtual antenna-pattern-weighted delay-multiply-and-sum (APW-DMAS) technique based on a plurality of positions of each virtual antenna to determine a plurality of object signature images;
extract, at least one feature associated with the plurality of object signature images; and
obtain, a trained classification model based on at least one feature associated with the plurality of object signature images, wherein the trained classification model identifies class of each object under test from among a plurality of object under test moving on the conveyor.

7. The system of claim 6, wherein the plurality of parameters corresponds to: (i) speed of the conveyor, (ii) length (L) of the conveyor available for imaging that is determined from a position and a beamwidth of the plurality of antenna pairs, and (iii) number of scans (M).

8. The system of claim 6, wherein the plurality of range-time datasets corresponds to a form of a two-dimensional matrix, where the rows are the scans at each time instant, and the columns are the range bins.

9. The system of claim 6, wherein the plurality of object signature images is determined by a pattern factor derived based on a radiation pattern from the plurality of antenna pairs, and wherein the pattern factor corresponds to a synthetic weight factor that heuristically incorporates directivity and gain of each antenna.

10. The system of claim 6, wherein a confidence score for an unknown test object is obtained from the trained classification model to recognize if there is a false alarm raised when the object under test is classified.

11. One or more non-transitory machine-readable information storage mediums comprising one or more instructions which when executed by one or more hardware processors cause:
receiving, a plurality of parameters associated with a conveyor;
obtaining, a scan time of a radar based on the plurality of parameters, wherein the scan time is divided into equal parts for each antenna pair (Tx-Rx) from a plurality of antenna pairs, wherein time interval between each scan is determined based on the scan time of the radar;
determining, sequence of scanning between the plurality of antenna pairs based on corresponding position of the plurality of antenna pairs;
heuristically determining, a color threshold value of a predetermined position in a camera observation window on the conveyor, wherein if the color threshold value is exceeded as front end of an object under test packed inside a sealed package crosses the predetermined position on the conveyor, and scanning is triggered, and wherein the color threshold value corresponds to a plurality of RGB values;
scanning, via the radar connected with the plurality of antenna pairs, the sealed package in the predetermined sequence to obtain a plurality of range-time datasets associated with a plurality of identifiers, wherein the plurality of range-time datasets corresponds to a plurality of reflected signals from the object under test having continuous motion on the conveyer;
processing, the plurality of range-time datasets by a virtual antenna-pattern-weighted delay-multiply-and-sum (APW-DMAS) technique based on a plurality of positions of each virtual antenna to determine a plurality of object signature images;
extracting, at least one feature associated with the plurality of object signature images; and
obtaining, a trained classification model based on at least one feature associated with the plurality of object signature images, wherein the trained classification model identifies class of each object under test from among a plurality of object under test moving on the conveyor.

12. The one or more non-transitory machine-readable information storage mediums of claim 11, wherein the plurality of parameters corresponds to: (i) speed of the conveyor, (ii) length (L) of the conveyor available for imaging that is determined from a position and a beamwidth of the plurality of antenna pairs, and (iii) number of scans (M).

13. The one or more non-transitory machine-readable information storage mediums of claim 11, wherein the plurality of range-time datasets corresponds to a form of a two-dimensional matrix, where the rows are the scans at each time instant, and the columns are the range bins.

14. The one or more non-transitory machine-readable information storage mediums of claim 11, wherein the plurality of object signature images is determined by a pattern factor derived based on a radiation pattern from the plurality of antenna pairs, and wherein the pattern factor corresponds to a synthetic weight factor that heuristically incorporates directivity and gain of each antenna.

15. The one or more non-transitory machine-readable information storage mediums of claim 11, wherein a confidence score for an unknown test object is obtained from the trained classification model to recognize if there is a false alarm raised when the object under test is classified.
